(19) United States
(12) Patent Application Publication
(10) Pub. No.: US 2026/0326493 A1
(43) Pub. Date: Oct. 22, 2026

(54) VEHICLE HEIGHT ADJUSTMENT DEVICE

(71) Applicant: HL MANDO CORPORATION, Pyeongtaek-si (KR)

(72) Inventors: Woojin JHONG, Pyeongtaek-si (KR); Jeonggil KIM, Pyeongtaek-si (KR); Gyutae LEE, Pyeongtaek-si (KR); Chunsung YU, Pyeongtaek-si (KR); Sewon CHO, Pyeongtaek-si (KR)

(73) Assignee: HL MANDO CORPORATION, Pyeongtaek-si (KR)

(21) Appl. No.: 19/649,638

(22) Filed: Apr. 16, 2026

(30) Foreign Application Priority Data
Apr. 17, 2025 (KR) 10-2025-0050115
Mar. 13, 2026 (KR) 10-2026-0045653

(51) Int. Cl. B60G 17/015

(52) U.S. Cl. CPC B60G 17/0152; B60G 2202/413; B60G 2202/416; B60G 2400/252

(57) ABSTRACT

A vehicle height adjustment device is disclosed, which includes: a shock absorber configured to be disposed between a chassis and a vehicle body of a vehicle; and an actuator configured to include an actuator body disposed to surround an outer circumferential surface of a body of the shock absorber, and configured to form an actuating chamber filled with a fluid between the outer circumferential surface of the body of the shock absorber and an inner circumferential surface of the actuator body. As the fluid is supplied or recovered to the actuating chamber, the actuator is axially displaced along the body of the shock absorber.

### CROSS-REFERENCE TO RELATED APPLICATION

The present application claims priority under 35 U.S.C. § 119(a) to Korean patent applications No. 10-2025-0050115 filed on Apr. 17, 2025, No. 10-2026-0045653, filed on Mar. 13, 2026, in the Korean Intellectual Property Office, the entire disclosures of which are incorporated herein by reference.

### BACKGROUND

### 1. Technical Field

The present disclosure relates to a vehicle height adjustment device, and more particularly to a vehicle height adjustment device that adjusts a vehicle height by changing a distance between a chassis of a vehicle and a vehicle body.

### 2. Related Art

A vehicle height adjustment device adjusts a vehicle height by adjusting a relative position between a sprung mass side and an unsprung mass side of a vehicle. By actively adjusting the vehicle height through the vehicle height adjustment device, it is possible to protect the underbody of the vehicle by increasing the vehicle height or to improve fuel efficiency by reducing the vehicle height. In addition, the active vehicle height adjustment enables passengers to more conveniently get in and out of the vehicle and enables cargo to be more conveniently loaded and unloaded.

In order for the vehicle height adjustment device to be widely applied to vehicles, the vehicle height adjustment device is required to be lighter and smaller. In addition, there is a need to develop a structure that can be universally installed regardless of the type of suspension system, such as Double Wishbone, MacPherson strut or the like.

### SUMMARY

An object of the present disclosure is to provide a vehicle height adjustment device in which an axial package is miniaturized to be easily mounted on a vehicle suspension.

Another object of the present disclosure is to provide a vehicle height adjustment device capable of effectively increasing an axial travel range.

The objects of the present disclosure are not limited to the above-described objects, and other objects that are not mentioned will be able to be clearly understood by those skilled in the art to which the present disclosure pertains from the following description.

According to the embodiment of the present disclosure, a vehicle height adjustment device is provided, which includes: a shock absorber configured to be disposed between a chassis and a vehicle body of a vehicle; and an actuator configured to include an actuator body disposed to surround an outer circumferential surface of a body of the shock absorber, and configured to form an actuating chamber filled with a fluid between the outer circumferential surface of the body of the shock absorber and an inner circumferential surface of the actuator body. As the fluid is supplied or recovered to the actuating chamber, the actuator is axially displaced along the body of the shock absorber.

The vehicle height adjustment device according to the embodiment of the present disclosure may further include a spring seat which is coupled to an outer circumferential surface of the actuator body and moves integrally with the actuator. At least a portion of the actuating chamber may be disposed closer to the vehicle body side than the spring seat.

In the vehicle height adjustment device according to the embodiment of the present disclosure, the actuator may further include an actuator port which passes through the actuator body such that the fluid is introduced into the actuating chamber, and which is disposed closer to the vehicle body side than the spring seat.

In the vehicle height adjustment device according to the embodiment of the present disclosure, a stopper which protrudes radially outward and limits an axial displacement of the actuator body may be formed on the outer circumferential surface of the body of the shock absorber.

In the vehicle height adjustment device according to the embodiment of the present disclosure, an inwardly protruding portion protruding radially inward and defining an upper boundary of the actuating chamber may be provided on the inner circumferential surface of the actuator body.

In the vehicle height adjustment device according to the embodiment of the present disclosure, a first groove may be formed to be recessed in an inner circumferential surface of the inwardly protruding portion, and a first sealing member which seals between the inwardly protruding portion and the outer circumferential surface of the body of the shock absorber may be disposed in the first groove.

In the vehicle height adjustment device according to the embodiment of the present disclosure, an outwardly protruding portion protruding radially outward from a lower portion of the inwardly protruding portion and defining a lower boundary of the actuating chamber may be provided on the outer circumferential surface of the body of the shock absorber.

In the vehicle height adjustment device according to the embodiment of the present disclosure, the body of the shock absorber may include a first outer diameter portion and a second outer diameter portion which has a smaller diameter and extends closer to the vehicle body side than the first outer diameter portion. A section between a lower end portion of the actuator body, which faces the chassis, and the inwardly protruding portion may have an inner diameter corresponding to the first outer diameter portion.

In the vehicle height adjustment device according to the embodiment of the present disclosure, a second groove may be formed to be recessed in the outer circumferential surface of the body of the shock absorber. A second sealing member which seals between the inner circumferential surface of the actuator body and the outer circumferential surface of the body of the shock absorber may be disposed in the second groove.

In the vehicle height adjustment device according to the embodiment of the present disclosure, a third groove may be formed to be recessed in in the outer circumferential surface of the body of the shock absorber along the circumference, and a bush may be disposed in the third groove.

In the vehicle height adjustment device according to the embodiment of the present disclosure, a key groove may be formed to be recessed in the outer circumferential surface of the body of the shock absorber in the axial direction, and a key which is inserted into the key groove and limits rotation of the actuator during an axial displacement of the actuator may be disposed on the actuator.

The vehicle height adjustment device according to the embodiment of the present disclosure may further include a spring seat which is coupled to an outer circumferential surface of the actuator body and moves integrally with the actuator. The key groove and the key may be disposed below the spring seat in such a manner as to be closer to the chassis side than the spring seat.

According to another embodiment of the present disclosure, a vehicle height adjustment device is provided, which includes: a pump configured to supply or recover a fluid; an actuator configured to include an actuator body disposed to surround an outer circumferential surface of a body of a shock absorber disposed between a chassis and a vehicle body of a vehicle, and configured to form an actuating chamber filled with a fluid supplied or recovered by the pump between the outer circumferential surface of the body of the shock absorber and an inner circumferential surface of the actuator body; a spring seat configured to be coupled to an outer circumferential surface of the actuator body; and a hydraulic line configured to be disposed to fluidly communicate the pump with the actuating chamber above the spring seat, that is, at a position closer to the vehicle body side than the spring seat. The spring seat and the hydraulic line are axially displaced integrally with the actuator.

In the vehicle height adjustment device according to the embodiment of the present disclosure, a spring seat hole through which the hydraulic line passes may be formed in the spring seat. The hydraulic line may be disposed to pass through the spring seat hole.

In the vehicle height adjustment device according to the embodiment of the present disclosure, at least a portion of the actuating chamber may be disposed closer to the vehicle body side than the spring seat.

In the vehicle height adjustment device according to the embodiment of the present disclosure, an inwardly protruding portion protruding radially inward and defining an upper boundary of the actuating chamber may be formed on the inner circumferential surface of the actuator body.

In the vehicle height adjustment device according to the embodiment of the present disclosure, an outwardly protruding portion protruding radially outward from a lower portion of the inwardly protruding portion and defining a lower boundary of the actuating chamber may be provided on the outer circumferential surface of the body of the shock absorber.

In the vehicle height adjustment device according to the embodiment of the present disclosure, the body of the shock absorber may include a first outer diameter portion and a second outer diameter portion which has a smaller diameter and extends closer to the vehicle body side than the first outer diameter portion. A section between a lower end portion of the actuator body, which faces the chassis, and the inwardly protruding portion may have an inner diameter corresponding to the first outer diameter portion.

In the vehicle height adjustment device according to the embodiment of the present disclosure, a key groove may be formed to be recessed in the outer circumferential surface of the body of the shock absorber in the axial direction, and a key which is inserted into the key groove and limits rotation of the actuator during an axial displacement of the actuator may be disposed on the actuator.

In the vehicle height adjustment device according to the embodiment of the present disclosure, the key groove and the key are disposed below the spring seat in such a manner as to be closer to the chassis side than the spring seat.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view showing components of a vehicle height adjustment device according to an embodiment of the present disclosure.

FIG. 2 is a perspective view showing a pump, an actuator, and a spring seat of the vehicle height adjustment device according to the embodiment of the present disclosure.

FIG. 3 is an exploded perspective view of certain components of the vehicle height adjustment device according to the embodiment of the present disclosure.

FIG. 4 is a longitudinal cross-sectional view of the actuator of the vehicle height adjustment device according to the embodiment of the present disclosure.

FIG. 5 is a view showing a configuration for limiting rotation during axial displacement of the actuator of the vehicle height adjustment device according to the embodiment of the present disclosure.

FIG. 6 is a view showing a state in which the actuator of the vehicle height adjustment device according to the embodiment of the present disclosure is disposed at a lower end of an axial travel range.

FIG. 7 is a view showing a state in which the actuator of the vehicle height adjustment device according to the embodiment of the present disclosure is disposed in the middle of the axial travel range.

FIG. 8 is a view showing a state in which the actuator of the vehicle height adjustment device according to the embodiment of the present disclosure is disposed at an upper end of the axial travel range.

FIG. 9 is a view showing a modified example of a shock absorber and the actuator of the vehicle height adjustment device according to the embodiment of the present disclosure.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

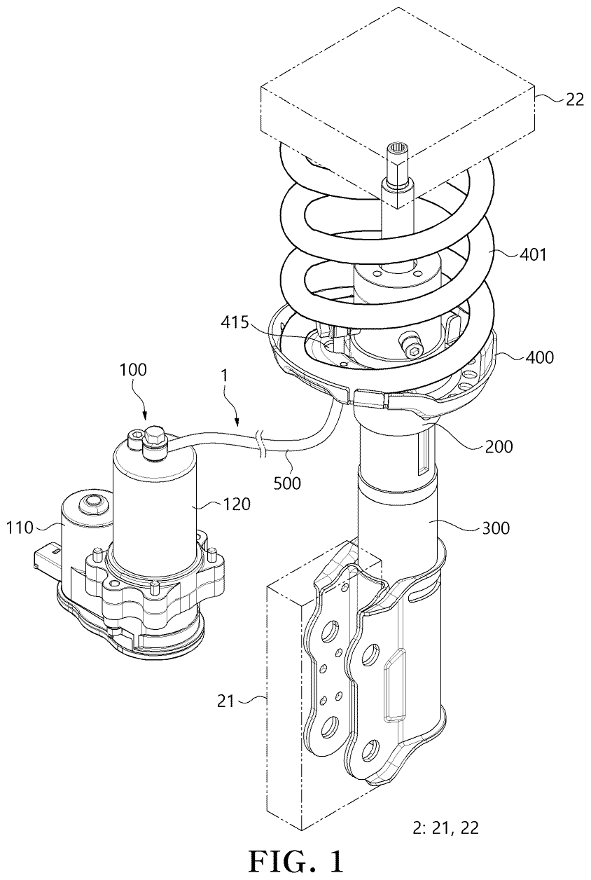

FIG. 1 is a view showing a configuration of a vehicle height adjustment device according to the embodiment of the present disclosure.

Referring to FIG. 1, a vehicle height adjustment device 1 may be installed in a vehicle 2 and may adjust a vehicle height. The vehicle height adjustment device 1 may be individually installed on each wheel side of the vehicle. More specifically, the vehicle height adjustment device 1 may be installed at each of a plurality of corners of the vehicle 2 and may independently adjust the vehicle height at each corner of the vehicle 2.

The vehicle height adjustment device 1 adjusts the vehicle height by adjusting a relative position between a vehicle body side and a wheel-side suspension system of the vehicle. For example, the vehicle height adjustment device 1 may adjust the height of the vehicle by adjusting a relative position between the vehicle body 22 side of the vehicle 2, that is, a sprung mass side and the wheel side, that is, an unsprung mass side.

The vehicle height adjustment device 1 may increase the vehicle height by increasing a relative distance between a chassis 21 and the vehicle body 22. In addition, the vehicle height adjustment device 1 may reduce the vehicle height by reducing the relative distance between the chassis 21 and the vehicle body 22. Hereinafter, the chassis 21 may refer to a component of the unsprung mass side of the vehicle 2.

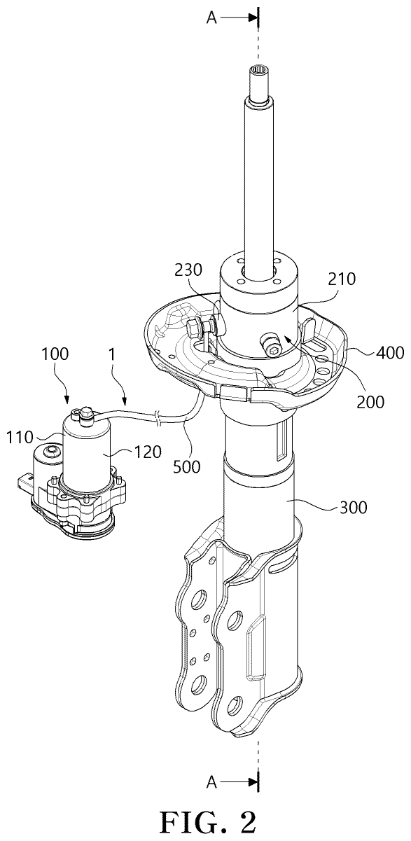

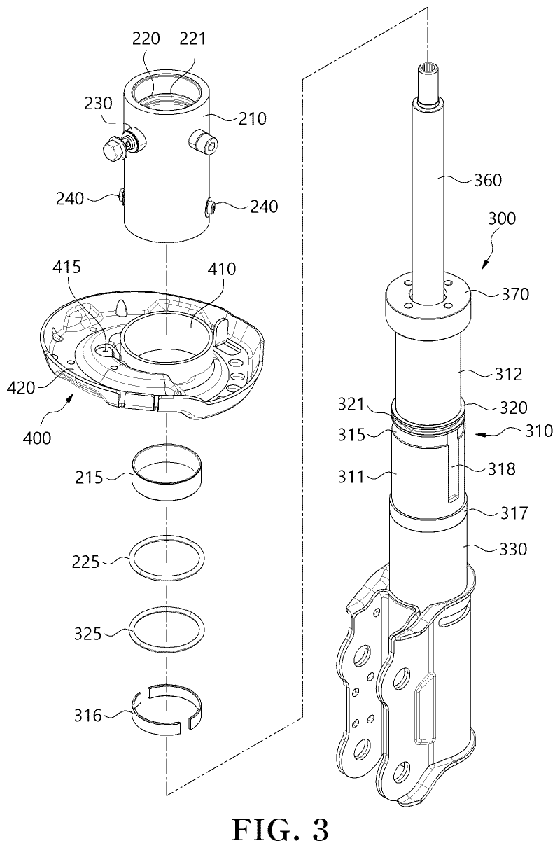

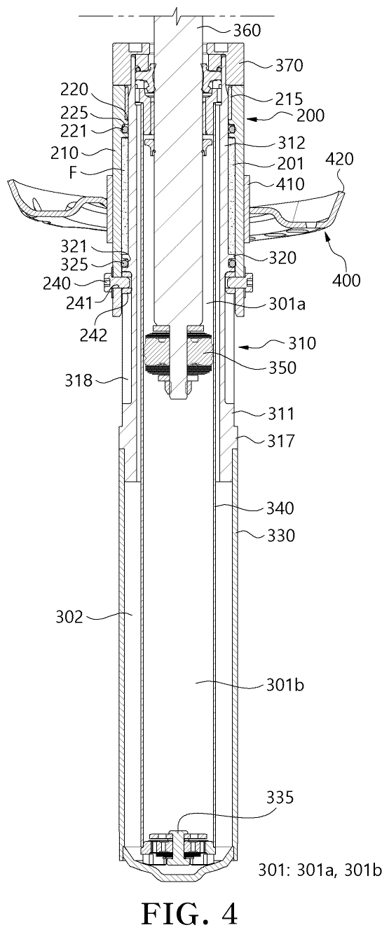

FIG. 2 is a perspective view of a pump, an actuator, and a spring seat of the vehicle height adjustment device according to the embodiment of the present disclosure. FIG. 3 is an exploded perspective view of certain components of the vehicle height adjustment device according to the embodiment of the present disclosure. FIG. 4 is a longitudinal cross-sectional view of the actuator of the vehicle height adjustment device according to the embodiment of the present disclosure.

Referring to FIGS. 1 to 4, the vehicle height adjustment device 1 may include a pump 100 and an actuator 200.

The pump 100 supplies or recovers a fluid. The fluid flowing by the pump 100 is a medium for increasing or decreasing the vehicle height. For example, the fluid may be oil. The pump 100 may supply the fluid to the actuator 200 or may recover the fluid from the actuator 200.

The pump 100 may operate in both directions. In other words, the pump 100 may operate in one direction to supply the fluid to the actuator 200 or may operate in the other direction to recover the fluid from the actuator 200.

The pump 100 may include a motor 110 and a piston unit 120. The motor 110 generates a driving force. The piston unit 120 is operated by the driving force of the motor 110 and causes the fluid to flow toward the actuator 200 or recovers the fluid from the actuator 200. The type or structure of the pump 100 is not limited by the embodiment of the present disclosure, and various types of pumps may be used.

The actuator 200 is disposed along an outer circumferential surface of a body 310 of a shock absorber 300 disposed between the chassis 21 and the vehicle body 22 of the vehicle 2 and is axially displaceable. The actuator 200 may be axially displaced by the fluid supplied or recovered by the pump 100.

Hereinafter, in the description of the relative positions of the components, a portion relatively close to the chassis 21 of the vehicle 2 is defined as a lower portion, and a portion relatively close to the vehicle body 22 of the vehicle 2 is defined as an upper portion. In addition, “axial direction” means a longitudinal direction of the shock absorber 300.

The actuator 200 includes an actuator body 210. The actuator body 210 is disposed to surround the outer circumferential surface of the body 310 of the shock absorber 300. As shown in FIG. 4, the actuator 200 is configured to form an actuating chamber 201 filled with the fluid supplied or recovered by the pump 100 between the outer circumferential surface of the body 310 of the shock absorber 300 and an inner circumferential surface of the actuator body 210.

The body 310 of the shock absorber 300 may be configured as a tube. Referring to FIG. 4, a base shell 330 may be coupled to a lower portion of the body 310 of the shock absorber 300. The base shell 330 may be configured as a tube which communicates with the body 310 of the shock absorber 300 and has a closed lower end thereof. The body 310 and the base shell 330 of the shock absorber 300 may form a chamber therein which is filled with a damping fluid for damping in a state in which they are coupled.

An intermediate tube 340 partitioning the chamber into a main chamber 301 and a reservoir chamber 302 may be disposed within the chamber formed by the body 310 and the base shell 330 of the shock absorber 300. The main chamber 301 may be formed within the intermediate tube 340, and the reservoir chamber 302 may be formed in an annular space between the intermediate tube 340 and the body 310 or the base shell 330. A base valve 335 may be disposed at a lower end of the intermediate tube 340. The main chamber 301 and the reservoir chamber 302 may communicate with each other through the base valve 335.

The shock absorber 300 may further include a piston 350 and a piston rod 360. The piston 350 is disposed to partition the main chamber 301 into an upper rebound chamber 301a and a lower compression chamber 301b. The piston rod 360 has its upper portion connected to the vehicle body 22 and its lower portion coupled to the piston 350 and is axially displaced.

The shock absorber 300 presented in connection with the embodiment of the present disclosure is exemplary. As long as the actuator 200 is able to form the actuating chamber between the actuator 200 and the shock absorber 300 and to axially move on the shock absorber 300, there is no particular limitation on the structure of the shock absorber 300 to which the vehicle height adjustment device 1 may be applied.

For example, the vehicle height adjustment device 1 may be applied to various structures of the shock absorber such as a shock absorber in which the intermediate tube is not disposed, a shock absorber in the form of a triple tube in which an inner tube is additionally disposed within the intermediate tube, or a shock absorber in which the piston 350 and the piston rod 360 are fixed within the chamber, the piston rod 360 being disposed in an opposing relationship in the axial direction, and in which the intermediate tube is connected to the vehicle body and is axially displaced.

A spring seat 400 is coupled to an outer circumferential surface of the actuator body 210 and moves integrally with the actuator 200. For example, the spring seat 400 may be coupled to the outer circumferential surface of the actuator body 210 by welding or the like. A spring 401 may be disposed between the spring seat 400 and the vehicle body 22. The spring 401 together with the shock absorber 300 reduces the impact transmitted from a road surface to the vehicle body 22.

The spring seat 400 together with the actuator 200 may be vertically displaced on an outer circumferential surface of the shock absorber 300. The vehicle height adjustment device 1 may increase the vehicle height by displacing the spring seat 400 in a direction toward the vehicle body 22, that is, upward, and thus, by causing the spring 401 to lift the vehicle body 22, or may decrease the vehicle height by displacing the spring seat 400 in a direction toward the chassis 21, that is, downward, and thus, by lowering the vehicle body 22. The shock absorber 300 and the spring 401 may be tensioned or compressed in the process in which the vehicle height adjustment device 1 actively adjusts the vehicle height.

Referring to FIGS. 3 and 4, the spring seat 400 may include a cylinder portion 410 coupled to the outer circumferential surface of the actuator body 210 and a flange portion 420 extending radially outward from an outer circumferential surface of the cylinder portion 410 such that the spring 401 is seated. The cylinder portion 410 may have an inner diameter corresponding to an outer diameter of the actuator body 210 and may be coupled to the actuator body 210 by welding or the like.

As shown in FIGS. 3 and 4, an inwardly protruding portion 220 protruding radially inward and defining an upper boundary of the actuating chamber 201 may be provided on the inner circumferential surface of the actuator body 210.

In addition, an outwardly protruding portion 320 protruding radially outward from a lower portion of the inwardly protruding portion 220 and defining a lower boundary of the actuating chamber 201 may be provided on the outer circumferential surface of the body 310 of the shock absorber 300.

In summary, the actuating chamber 201 may be formed as an annular chamber. An outer circumferential surface of the actuating chamber 201 may be formed by the actuator body 210, and an inner circumferential surface of the actuating chamber 201 may be formed by the body 310 of the shock absorber 300. In addition, an upper end of the actuating chamber 201 may be defined by the inwardly protruding portion 220 of the actuator 200, and a lower end of the actuating chamber 201 may be defined by the outwardly protruding portion 320 provided in the body 310 of the shock absorber 300.

Meanwhile, the body 310 of the shock absorber 300 may include a first outer diameter portion 311 and a second outer diameter portion 312 which has a smaller diameter and extends closer to the vehicle body 22 than the first outer diameter portion 311. In addition, a section between a lower end portion of the actuator body 210, which faces the chassis 21, and the inwardly protruding portion 220 may have an inner diameter corresponding to the first outer diameter portion 311. In this case, when the actuator 200 axially displaces, the inner circumferential surface of the actuator body 210 may be supported by the first outer diameter portion 311, and the axial displacement can be stably guided.

If the actuating chamber 201 is formed between the actuator body 210 and the second outer diameter portion 312 which has a smaller diameter than that of the first outer diameter portion 311 of the body 310 of the shock absorber 300, it is possible to suppress a radial increase of a package even though the actuator 200 is mounted on the shock absorber 300.

At least a portion of the actuating chamber 201 may be disposed closer to the vehicle body 22 side than the spring seat 400. In other words, the actuating chamber 201 may be disposed above the spring seat 400. Accordingly, an empty space existing between the shock absorber 300 and the spring 401 may be utilized for the installation of the actuator 200.

In this regard, an actuator port 230 of the actuator 200 may be disposed closer to the vehicle body 22 side than the spring seat 400. That is, the actuator 200 may further include the actuator port 230 which passes through the actuator body 210 such that the fluid supplied or recovered by the pump 100 can be introduced into the actuating chamber 201, and which is disposed closer to the vehicle body 22 side than the spring seat 400.

In addition, the vehicle height adjustment device 1 may further include a hydraulic line 500 which is disposed to fluidly communicate the pump 100 with the actuating chamber 201. The hydraulic line 500 may be connected to the actuator port 230. The actuator port 230 may be in fluid communication with the actuating chamber 201. Further, the hydraulic lines 500 may displace together with the actuator 200 in accordance with the displacement of the actuator 200.

For example, the hydraulic line 500 may be configured as a hose. In relation to the above-described position of the actuating chamber 201, the hydraulic line 500 may fluidly communicate the pump 100 with the actuating chamber 201 above the spring seat 400, that is, at a position closer to the vehicle body 22 side than the spring seat 400.

In this regard, a spring seat hole 415 through which the hydraulic line 500 may pass may be formed in the spring seat 400 (see FIGS. 1 and 3). The hydraulic line 500 may be disposed to pass through the spring seat hole 415.

A space for preventing mutual interference between the wheel of the vehicle 2 and the portion of the shock absorber 300 disposed below the spring seat 400 is required. Accordingly, there is a significant limitation on installing additional equipment on the outer circumferential surface of the shock absorber 300.

According to the embodiment of the present disclosure, as the actuating chamber 201 is disposed at an upper portion of the spring seat 400, it is possible to cause the actuator 200 to occupy a minimize lower space of the spring seat 400. In other words, the structure in which at least a portion of the actuating chamber 201 is formed on the upper portion of the spring seat 400 can minimize an installation space within the vehicle 2 required for the installation of the vehicle height adjustment device 1. As a result, the mountability and versatility of the vehicle height adjustment device 1 can be improved.

Meanwhile, a first groove 221 may be formed to be recessed in an inner circumferential surface of the inwardly protruding portion 220 of the actuator 200. A first sealing member 225 which seals between the inwardly protruding portion 220 and the body 310 of the shock absorber 300 may be disposed in the first groove 221. For example, the first sealing member 225 may be an O-ring.

Since the inwardly protruding portion 220 of the actuator 200 defines the upper boundary of the actuating chamber 201, it is necessary to prevent the fluid used for the height adjustment from leaking between the inwardly protruding portion 220 and the shock absorber 300. The first sealing member 225 seals between the inwardly protruding portion 220 and the outer circumferential surface of the body 310 of the shock absorber 300, thereby preventing the leakage of the fluid.

In addition, a second groove 321 may be formed to be recessed in an outer circumferential surface of the outwardly protruding portion 320 of the shock absorber 300. The second groove 321 may be formed in the outer circumferential surface of the outwardly protruding portion 320 along the circumference.

A second sealing member 325 which seals between the actuator body 210 and the body 310 of the shock absorber 300 may be disposed in the second groove 321. For example, the second sealing member 325 may be an O-ring.

As described above, the lower boundary of the actuating chamber 201 is defined by the outwardly protruding portion 320 provided on the body 310 of the shock absorber 300. The second sealing member 325 seals between the actuator body 210 and the outer circumferential surface of the body 310 of the shock absorber 300, thereby preventing the fluid from flowing downward through a stepped portion formed by the outwardly protruding portion 320.

The actuating chamber 201 may be substantially sealed by the first sealing member 225 and the second sealing member 325 to maintain a pressure of the fluid.

A first bush 215 may be disposed in a section between the inwardly protruding portion 220 of the actuator body 210 and an upper end portion of the actuator body 210, which faces the vehicle body 22 in such a manner as to be interposed in a gap between the body 310 of the shock absorber 300 and the actuator body 210.

Referring to FIG. 3, a third groove 315 may be formed to be recessed in the outer circumferential surface of the body 310 of the shock absorber 300 along the circumference. The third groove 315 may be formed between the first outer diameter portion 311 and the outwardly protruding portion 320 of the body 310 of the shock absorber 300 along the circumference.

A second bush 316 may be disposed in the third groove 315. The second bush 316 may be disposed in contact with the inner circumferential surface of the actuator body 210.

The first bush 215 and the second bush 316 may be formed of, for example, a resin-based (PTFE-based) or metal-based bearing member.

As the fluid is introduced from the pump 100 into the actuating chamber 201 or the fluid is recovered from the actuating chamber 201 to the pump 100, the actuator 200 axially displaces on the body 310 of the shock absorber 300. The first bush 215 and the second bush 316 may reduce the friction during the axial displacement of the actuator 200 simultaneously with supporting the actuator 200.

In relation to the axial displacement of the actuator 200, a stopper 317 which protrudes radially outward and limits the displacement of the actuator body 210 toward the chassis 21 may be formed on the outer circumferential surface of the body 310 of the shock absorber 300. The stopper 317 may be disposed below and spaced apart from the second groove 321 and the third groove 315. The stopper 317 may be configured as a flange protruding radially from the body 310 of the shock absorber 300.

Meanwhile, the shock absorber 300 may further include a cap 370 which closes an upper end portion of the shock absorber 300. The cap 370 may be disposed to close an upper end portion of the body 310. Here, the cap 370 may perform a function of limiting the displacement of the actuator 200 toward the vehicle body 22. To this end, the cap 370 may have an outer diameter greater than that of the second outer diameter portion 312.

The displacement limit of the actuator 200 by the cap 370 is exemplary. The displacement of the actuator 200 toward the vehicle body 22 can be limited by components other than the cap 370. For example, it can also be considered that a flange-shaped stopper protruding radially outward is additionally formed on the body 310 of the shock absorber 300.

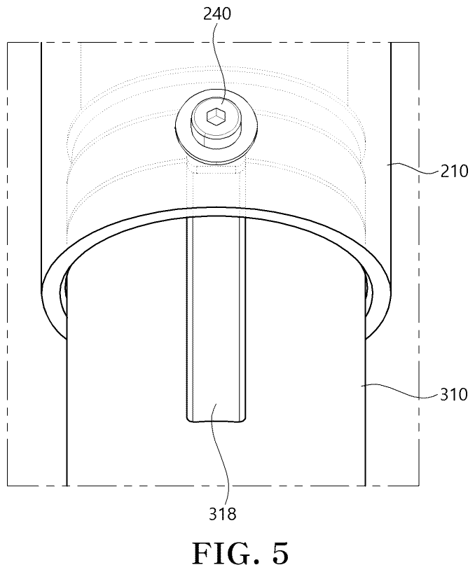

FIG. 5 is a view showing a configuration for limiting rotation during the axial displacement of the actuator of the vehicle height adjustment device according to the embodiment of the present disclosure.

In order to efficiently perform the height adjustment by the vehicle height adjustment device 1, the actuator 200 should be limited from rotating relative to the shock absorber 300 during the axial displacement of the actuator 200.

Referring to FIG. 5, a key groove 318 may be formed to be recessed in the outer circumferential surface of the body 310 of the shock absorber 300 in the axial direction. In response to this, a key 240 may be disposed on the actuator 200. The key 240 is inserted into the key groove 318 and is axially displaced during the axial displacement of the actuator 200, and limits the rotation of the actuator 200

The key groove 318 and the key 240 may be disposed below the spring seat 400 in such a manner as to be closer to the chassis 21 than the spring seat 400. Meanwhile, a pair of the key grooves 318 may be formed to be spaced apart from each other along the circumference of the shock absorber 300, and a pair of the keys 240 may be provided correspondingly.

Referring to FIG. 3, the key groove 318 may be formed below the outwardly protruding portion 320 of the shock absorber 300. More specifically, the key groove 318 may extend across the third groove 315 in the axial direction from a lower side of the third groove 315 to a lower end of the outwardly protruding portion 320.

Through this structure, it is possible to secure a sufficient length of the key groove 318 on the shock absorber 300. In this case, when the key 240 is displaced along the key groove 318, interference with the second bush 316 disposed in the third groove 315 should be avoided. In consideration of this, the second bush 316 may have a discontinuous interrupted structure along the interrupted circumference so as not to occupy the key groove 318 portion.

Referring to FIG. 4, a key coupling hole 241 passing through the outer circumferential surface and the inner circumferential surface of the actuator body 210 for coupling the key 240 may be formed in the actuator body 210, and the key 240 may be coupled to the key coupling hole 241. In this case, since the key 240 may be coupled after the actuator 200 is mounted on the shock absorber 300, manufacturing efficiency of the vehicle height adjustment device 1 can be improved.

In addition, the actuator body 210 may further include a key fastening member 242 therein. The key fastening member 242 is coupled to an end of the key 240 disposed through the key coupling hole 241 and prevents the key 240 from being separated from the key coupling hole 241. For example, the key 240 may be configured as a bolt, and the key fastening member 242 may be configured as a nut. Meanwhile, the key 240 or the key fastening member 242 may be caught by a lower end of the key groove 318 when the actuator 200 is axially displaced downward and may function as a stopper.

Hereinabove, the configuration of the vehicle height adjustment device 1 according to the embodiment of the present disclosure has been described in detail. Hereinafter, an operation of the vehicle height adjustment device 1 will be described.

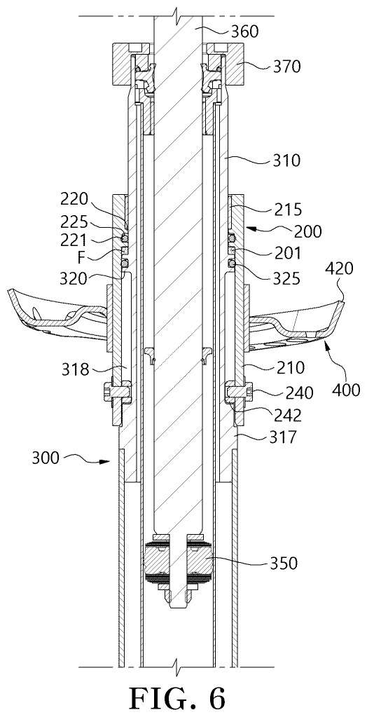

FIG. 6 is a view showing a state in which the actuator of the vehicle height adjustment device according to the embodiment of the present disclosure is disposed at a lower end of an axial travel range.

Referring to FIG. 6, the actuator 200 is seated on the stopper 317 of the shock absorber 300. In this state, the vehicle height is shown at its minimum value. That is, the stopper 317 defines a lower limit of the axial displacement of the actuator 200.

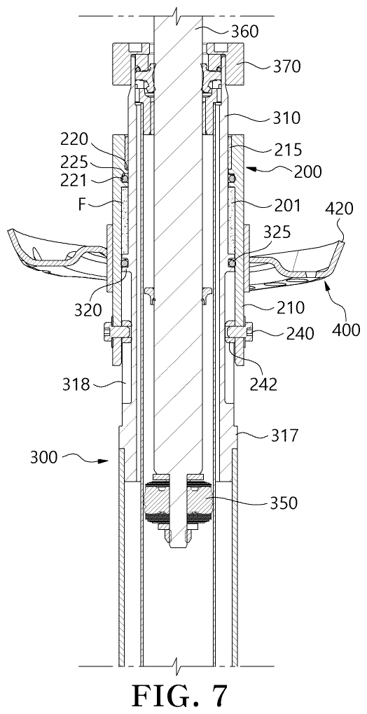

FIG. 7 is a view showing a state in which the actuator of the vehicle height adjustment device according to the embodiment of the present disclosure is disposed in the middle of the axial travel range.

Referring to FIG. 7, if the pump 100 operates to supply a fluid F to the actuating chamber 201, the fluid F is introduced into the actuating chamber 201 through the hydraulic line 500 and the actuator port 230.

Accordingly, a volume of the actuating chamber 201 increases, and the actuator 200 is displaced upward in the axial direction by the pressure of the fluid F introduced into the actuating chamber 201. More specifically, the pressure of the fluid F introduced into the actuating chamber 201 may act on an axial action surface of the actuator 200 (e.g., an annular cross-section of the inwardly protruding portion 220 and/or the actuator body 210) and may generate an upward force on the actuator 200.

As the actuator 200 moves upward, the position of the spring seat 400 rises. Accordingly, a support point of the spring 401 rises, and the relative position between the vehicle body 22 and the wheel-side suspension system is changed, so that the vehicle height may be increased. Here, the hydraulic line 500 may be axially displaced integrally with the actuator 200 and the spring seat 400.

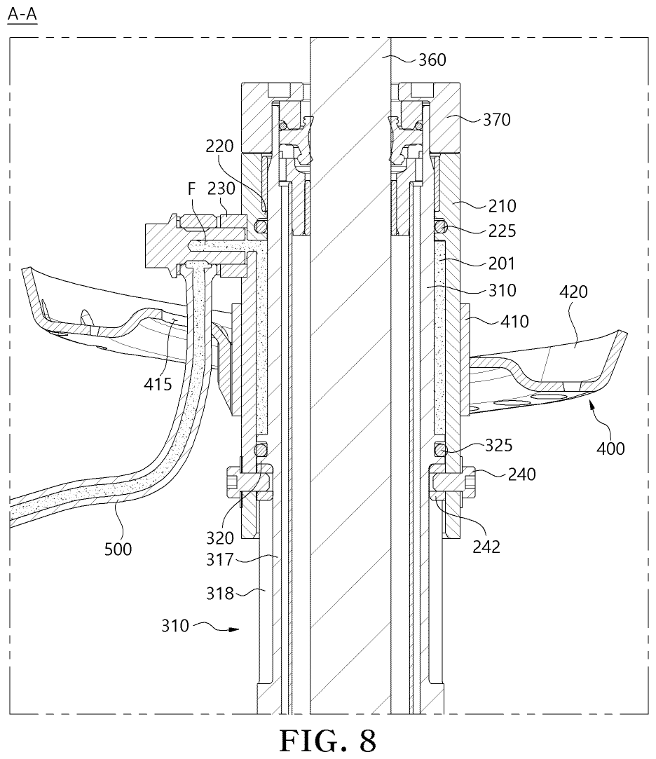

FIG. 8 is a view showing a state in which the actuator of the vehicle height adjustment device according to the embodiment of the present disclosure is disposed at an upper end of the axial travel range. FIG. 8 is a cross-sectional view taken along line A-A′ of FIG. 2 in order to clearly show a connection relationship between the hydraulic line 500 and the actuator port 230.

As the fluid F continuously flows into the actuating chamber 201 through the hydraulic line 500 and the actuator port 230, the volume of the actuating chamber 201 additionally increases, and the actuator 200 rises in the axial direction due to the pressure of the fluid F flowing into the actuating chamber 201 until the actuator contacts the cap 370 of the shock absorber 300. In other words, the cap 370 defines an upper limit of the axial displacement of the actuator 200.

Meanwhile, if the pump 100 operates in a direction in which the fluid F is recovered from the actuating chamber 201 to the pump 100 side, the actuator 200 is axially displaced downward while the volume of the actuating chamber 201 is reduced. Accordingly, the vehicle height may be reduced.

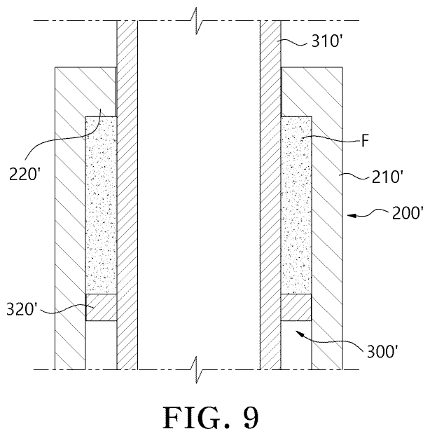

FIG. 9 is a view showing a modified example of the shock absorber and the actuator of the vehicle height adjustment device according to the embodiment of the present disclosure. FIG. 9 briefly shows modified components of the shock absorber and the actuator compared to the above-described embodiment of the present disclosure, and components irrelevant to the description are omitted.

Referring to FIG. 9, the vehicle height adjustment device according to the embodiment of the present disclosure may be applied even when an outer diameter of a body 310′ of a shock absorber 300′ is formed uniformly. More specifically, when an inner diameter of an actuator body 210′ is formed to be larger than the outer diameter of the body 310′ of the shock absorber 300′ and an upper end of the actuating chamber is defined by an inwardly protruding portion 220′ protruding radially inward from an inner circumferential surface of the actuator body 210′ so as to contact the body 310′ of the shock absorber 300′, an outwardly protruding portion 320′ is formed on an outer circumferential surface of the body 310′ of the shock absorber 300′ through a separate member, thereby defining a lower end of the actuating chamber.

For example, the outwardly protruding portion 320′ may be configured as a ring-shaped member, a sleeve, or the like. In addition, the outwardly protruding portion 320′ may be coupled to the outer circumferential surface of the body 310′ of the shock absorber 300′ by a welding or the like.

As the fluid F is supplied into the actuating chamber, an actuator 200′ may be axially displaced upward on the shock absorber 300′. As the fluid F is recovered from the inside of the actuating chamber to the outside, the actuator 200′ may be axially displaced downwardly on the shock absorber 300′.

According to the above configuration, the vehicle height adjustment device according to embodiment of the present disclosure has a structure that is mounted on the shock absorber of a suspension system and suppresses an increase in the outer diameter of the shock absorber, so that a package becomes smaller and the vehicle height adjustment device is easily mounted on the vehicle.

The vehicle height adjustment device according to the embodiment of the present disclosure has a structure in which the actuating chamber extends to a space above the spring seat, which is easier to secure a space below the spring seat of the suspension system. Accordingly, the axial travel range of the vehicle height adjustment device is efficiently increased.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A vehicle height adjustment device comprising:
a shock absorber configured to be disposed between a chassis and a vehicle body of a vehicle; and
an actuator comprising an actuator body disposed to surround an outer circumferential surface of a body of the shock absorber, and configured to form an actuating chamber filled with a fluid between the outer circumferential surface of the body of the shock absorber and an inner circumferential surface of the actuator body,
wherein, as the fluid is supplied or recovered to the actuating chamber, the actuator is axially displaced along the body of the shock absorber.

2. The vehicle height adjustment device of claim 1, further comprising a spring seat which is coupled to an outer circumferential surface of the actuator body and moves integrally with the actuator, wherein at least a portion of the actuating chamber is disposed closer to the vehicle body side than the spring seat.

3. The vehicle height adjustment device of claim 2, wherein the actuator further comprises an actuator port which passes through the actuator body such that the fluid is introduced into the actuating chamber, and which is disposed closer to the vehicle body side than the spring seat.

4. The vehicle height adjustment device of claim 1, wherein a stopper which protrudes radially outward and limits an axial displacement of the actuator body is formed on the outer circumferential surface of the body of the shock absorber.

5. The vehicle height adjustment device of claim 1, wherein an inwardly protruding portion protruding radially inward and defining an upper boundary of the actuating chamber is provided on the inner circumferential surface of the actuator body.

6. The vehicle height adjustment device of claim 5, wherein a first groove is formed to be recessed in an inner circumferential surface of the inwardly protruding portion, and a first sealing member which seals between the inwardly protruding portion and the outer circumferential surface of the body of the shock absorber is disposed in the first groove.

7. The vehicle height adjustment device of claim 5, wherein an outwardly protruding portion protruding radially outward from a lower portion of the inwardly protruding portion and defining a lower boundary of the actuating chamber is provided on the outer circumferential surface of the body of the shock absorber.

8. The vehicle height adjustment device of claim 5,
wherein the body of the shock absorber comprises a first outer diameter portion and a second outer diameter portion which has a smaller diameter and extends closer to the vehicle body side than the first outer diameter portion, and
wherein a section between a lower end portion of the actuator body, which faces the chassis, and the inwardly protruding portion has an inner diameter corresponding to the first outer diameter portion.

9. The vehicle height adjustment device of claim 1, wherein a second groove is formed to be recessed in the outer circumferential surface of the body of the shock absorber, and wherein a second sealing member which seals between the inner circumferential surface of the actuator body and the outer circumferential surface of the body of the shock absorber is disposed in the second groove.

10. The vehicle height adjustment device of claim 1, wherein a third groove is formed to be recessed in in the outer circumferential surface of the body of the shock absorber along the circumference, and wherein a bush is disposed in the third groove.

11. The vehicle height adjustment device of claim 1, wherein a key groove is formed to be recessed in the outer circumferential surface of the body of the shock absorber in the axial direction, and wherein a key which is inserted into the key groove and limits rotation of the actuator during an axial displacement of the actuator is disposed on the actuator.

12. The vehicle height adjustment device of claim 11, further comprising a spring seat which is coupled to an outer circumferential surface of the actuator body and moves integrally with the actuator, wherein the key groove and the key are disposed below the spring seat in such a manner as to be closer to the chassis side than the spring seat.

13. A vehicle height adjustment device comprising:
a pump configured to supply or recover a fluid;
an actuator comprising an actuator body disposed to surround an outer circumferential surface of a body of a shock absorber disposed between a chassis and a vehicle body of a vehicle, and configured to form an actuating chamber filled with a fluid supplied or recovered by the pump between the outer circumferential surface of the body of the shock absorber and an inner circumferential surface of the actuator body;
a spring seat configured to be coupled to an outer circumferential surface of the actuator body; and
a hydraulic line configured to be disposed to fluidly communicate the pump with the actuating chamber above the spring seat, that is, at a position closer to the vehicle body side than the spring seat,
wherein the spring seat and the hydraulic line are axially displaced integrally with the actuator.

14. The vehicle height adjustment device of claim 13, wherein a spring seat hole through which the hydraulic line passes is formed in the spring seat, and wherein the hydraulic line is disposed to pass through the spring seat hole.

15. The vehicle height adjustment device of claim 13, wherein at least a portion of the actuating chamber is disposed closer to the vehicle body side than the spring seat.

16. The vehicle height adjustment device of claim 13, wherein an inwardly protruding portion protruding radially inward and defining an upper boundary of the actuating chamber is formed on the inner circumferential surface of the actuator body.

17. The vehicle height adjustment device of claim 16, wherein an outwardly protruding portion protruding radially outward from a lower portion of the inwardly protruding portion and defining a lower boundary of the actuating chamber is provided on the outer circumferential surface of the body of the shock absorber.

18. The vehicle height adjustment device of claim 16,
wherein the body of the shock absorber comprises a first outer diameter portion and a second outer diameter portion which has a smaller diameter and extends closer to the vehicle body side than the first outer diameter portion, and
wherein a section between a lower end portion of the actuator body, which faces the chassis, and the inwardly protruding portion has an inner diameter corresponding to the first outer diameter portion.

19. The vehicle height adjustment device of claim 13, wherein a key groove is formed to be recessed in the outer circumferential surface of the body of the shock absorber in the axial direction, and wherein a key which is inserted into the key groove and limits rotation of the actuator during an axial displacement of the actuator is disposed on the actuator.

20. The vehicle height adjustment device of claim 19, wherein the key groove and the key are disposed below the spring seat in such a manner as to be closer to the chassis side than the spring seat.
